(19) United States
(12) Patent Application Publication
(10) Pub. No.: US 2023/0172163 A1
(43) Pub. Date: Jun. 8, 2023

(54) RESTRAINT FOR ANIMAL UNDERGOING CERTAIN PROCEDURES

(71) Applicant: Amanda Jane Guidotti, Egg Harbor City, NJ (US)

(72) Inventor: Amanda Jane Guidotti, Egg Harbor City, NJ (US)

(21) Appl. No.: 18/048,220

(22) Filed: Oct. 20, 2022

Related U.S. Application Data
(60) Provisional application No. 63/264,882, filed on Dec. 3, 2021.

(51) Int. Cl. A01K 15/04; A61D 3/00

(52) U.S. Cl. CPC A01K 15/04; A61D 3/00

(57) ABSTRACT

A restraint including a first suspension member, a second suspension member, an elongated connector, and a saddle is disclosed. The first and second suspension members and saddle comfortably suspend an animal above a surface, which enables a procedure to be performed on an animal. The connector, arranged along a longitudinal axis, is configured to space the first and second suspension members apart and for enabling one of the suspension members to be rotatable about the axis relative to the other. The saddle has four spaced-apart end portions, removably attachable to projections on the first and second suspension members.

### CROSS-REFERENCE TO RELATED APPLICATION

This nonprovisional patent application is based upon provisional U.S. Ser. No. 63/264,882, filed Dec. 3, 2021, hereby incorporated by reference in its entirety.

### FIELD

The present subject matter is generally directed to devices to restrain animals, and more particularly, to devices to restrain animals undergoing medical procedures.

### BACKGROUND OF THE INVENTION

Animal restraining devices are well known. For example, U.S. Pat. No. 4,907,541 to Thompson and U.S. Pat. No. 6,253,713 to Giedeman, Ill et al. each disclose devices for restraining a pet such as a dog in a vehicle. U.S. Pat. No. 4,292,931 to Hopkins discloses a restraint device for shearing sheep. U.S. Pat. No. 4,911,106 to Goodwin discloses a restraining apparatus for grooming small animals such as cats. U.S. Pat. No. 4,055,148 to Brockman et al. discloses a restraining system for medically treating a variety of farm animals including swine, goats, sheep, cattle, and horses.

Domesticated animals including household pets and farm animals may need medical attention from time to time. For instance, certain pets such as canines with diabetes may require multiple insulin injections and multiple glucose checks daily. For such diabetic canines, injections and blood draws must be performed in different locations each time to prevent development of scar tissue, as owners know; and pets don't often cooperate to allow for such injections. Often, pets will wriggle, squirm, and possibly run away and/or become aggressive to avoid being injected with a needle.

Restraint devices disclosed in the prior art, after analysis, have been found to be either too cumbersome (e.g., U.S. Pat. No. 4,055,148) to be practical for pet owners, too stressful to a pet (U.S. Pat. No. 4,911,106), or otherwise inappropriate for this field.

As can be appreciated by pet owners wanting to provide a pet with medical procedures, there is a desire for a restraint device to gently cradle pets in a humane way to minimize stress, while enabling needed medical procedures to be performed.

The present subject matter is a restraint for household pets such as a dog. The restraint is portable, lightweight, foldable for storage when not in use, and easy to set up, to use when desired. The restraint exposes the pet's backside, enabling a person administering medication to move easily to different locations around the pet.

### SUMMARY OF THE INVENTION

One key aspect or feature of the present invention is its scalability. In other words, an animal restraint embodying principles of the present subject matter could be sized and configured to humanely restrain the domesticated farm animals noted.

Easy set up and ease of folding for storage purposes are additional features.

These and other aspects and features of the present subject matter will be better understood after reference to the following drawings, description, and claims.

### BRIEF DESCRIPTION OF THE DRAWINGS

FIG. 1 is a perspective view depicting an embodiment of the present subject matter in its desired operational mode, namely, humanely cradling a household pet.

FIG. 2, based on FIG. 1, presents various components and features of the present subject matter in its operational mode (but with the household pet removed).

FIG. 3, based upon FIG. 2 but on a reduced scale, shows one component of the present subject matter, separated from, and spaced above all other components.

FIG. 3A clearly depicts, on an enlarged scale, certain details shown in FIG. 3.

FIG. 4 is a side elevational depiction, on an enlarged scale relative to FIG. 3.

FIG. 5 is another side elevational depiction, presenting yet another feature of the present subject matter, which comparison of certain details in FIGS. 4, 5 clarifies.

FIG. 6 presents a side elevational view, illustrating a storage configuration.

Throughout the drawing figures and detailed description, similar reference numerals shall be used to refer to similar components of the present subject matter.

### DETAILED DESCRIPTION OF THE INVENTION

The following detailed description of an embodiment of the present subject matter presents an example of the best currently contemplated mode of using it. The following description and associated figures are not to be taken in a limiting sense but rather for purposes of describing features, advantages, and general principles, since the scope of the present subject matter is defined by the appended claims.

The present subject matter, in a broad sense, is a restraint comprising a frame and a saddle, for restraining a pet or another animal for medical and/or home care purposes, e.g., administer injections, withdraw blood, or perform other procedures.

The frame comprises two mutually parallel handrails, and four legs, a first two of which are unitary with and spaced from one of the two handrails. A second two of the legs are unitary with and spaced from the other one of the two handrails. Each leg includes an extendable and retractable foot to raise and lower the frame relative to a surface, such as a floor upon which the frame is usually placed when it is being used. A connector, joined to the frame, enables the handrails to be brought together, so that the volume of an in-use frame is reduced, for purposes of storing the frame.

While not limiting the materials of construction of the present subject matter, the frame including the handrails, legs and feet may be stainless steel for durability.

Attachment features, such as outward protrusions (preferably spherical), may be arranged at preselected locations along handrails for securing the saddle thereto.

In embodiments, the saddle may comprise cotton and/or fleece. The saddle, configured to support an animal, may include openings sized for the animal's limbs.

The restraint may be collapsed for storage by bringing the handrails together. The saddle may be detached from the handrails, if desired. With the saddle attached, the handrails may be spaced apart with frame feet oriented firmly on a floor, to enable orienting a pet on the saddle, with its limbs extending through the saddle openings.

In embodiments, when an animal is thus cradled in a saddle, the animal is fully supported by the saddle and its paws (or hooves) never contact the floor, which advantageously limits the animal's mobility, another feature of the present subject matter, for administering medical procedures and/or for providing grooming services.

The present subject matter accordingly enables an animal groomer or medical professional to maneuver 360 degrees entirely around an animal, e.g., a pet such a cat or dog. The present subject matter therefore enables such professionals to better access a pet's paws, tails, and ears more easily for medical attention and grooming.

One method of using the present subject matter may include grabbing and lifting one handrail, then moving the handrails apart and slightly shaking the saddle, to fully open. A user (such as an animal groomer or medical professional) may next extend or retract the feet (relative to the handrails), if needed, and thereafter place the feet onto a sturdy, flat surface. The user may next stand beside the saddle and then place an animal such as a canine atop the saddle, with all four limbs extending through respective saddle apertures. Thereafter, the medical professional may, e.g., administer insulin and/or check glucose readings from anywhere around the canine.

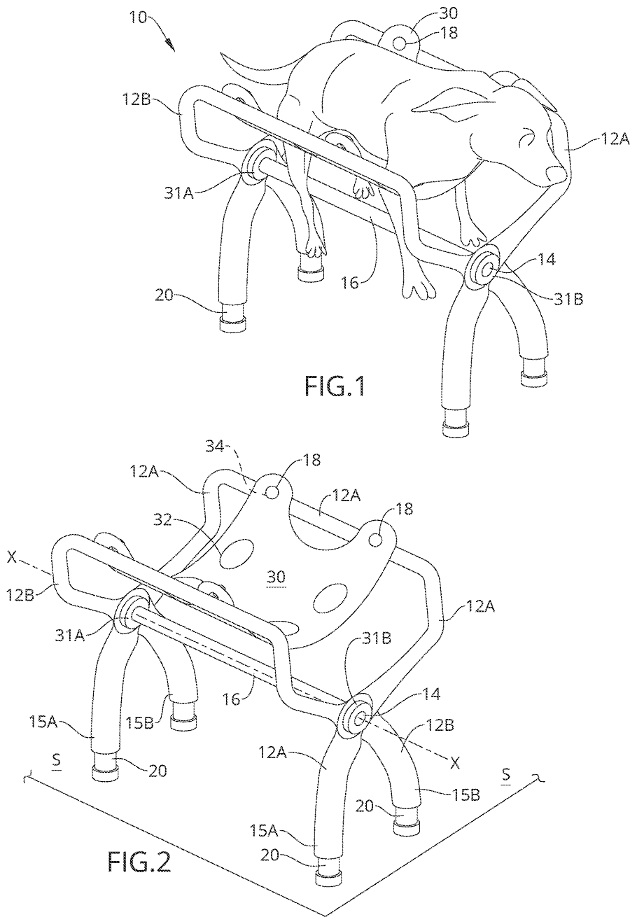

Referring to FIGS. 1-3, an embodiment of a restraint 10, designed to restrain an animal and for enabling a preselected procedure such as a medical procedure or an animal-grooming procedure to calmly take place shall now be described. While restrained, the animal is not unduly stressed during a grooming or medical session.

Throughout this patent specification, the term “restraint 10” is to be broadly construed, to be in accord with the purposes set forth throughout this specification.

The restraint 10 comprises a first suspension member 12A, a second suspension member 12B, an elongated connector 16, and a saddle 30 with several end portions. The first and second suspension members 12A, 12B are designed to suspend an animal above a surface S. The elongated connector 16, arranged along a longitudinal axis X-X, is designed to space the first and second suspension members 12A, 12B apart, yet allow one of the suspension members 12A, 12B to be rotatable about the axis X-X relative to the other suspension member. The saddle 30 has several (preferably four) spaced-apart end portions 33A, 33B, 33C, 33D.

The connector 16 is oriented along the first longitudinal axis X-X for pivotally connecting the first and second suspension members 12A and 12B, enabling one of the first and second members to be rotatable about the first axis X-X relative to the other one of the first and second suspension members, until structurally limited.

The first and second members 12A and 12B are each sized and configured to removably retain at least two of the end portions 33A, 33B, 33C, 33D of the saddle 30. In addition, the first suspension member 12A defines a first spaced-apart pair of legs 15A; and the second suspension member 12B also defines a second spaced-apart pair of legs 15B. When operative, the first pair of legs 15A are spaced from the second pair of legs 15B, for securely supporting the restraint 10 upon a surface S. The saddle 30 also defines a plurality of (preferably four) spaced-apart apertures 32.

The present subject matter is used to restrain a domesticated animal calmly, quietly, and in a manner that minimizes undue stress to the animal. In certain embodiments, the term “domesticated animal” may include swine, goats, sheep, cattle, and horses, while in other embodiments the term may include cats and dogs. A feature of restraint 10 that enables animals to remain calm will be described next.

In certain embodiments, the platform or saddle 30 component of the present subject matter may consist essentially of a commercially available soft-to-the-touch, yet pliable, and deformable elastomeric material. In addition, the first and second suspension members 12A, 12B may each define a U-shaped portion spaced from associated pairs of legs 15A, 15B. Moreover, the spaced-apart legs 15A of the first suspension member 12A and the spaced-apart legs 15B of the second suspension member 12B may each define open end portions located adjacent to the surface S.

The restraint 10 may further include four feet 20, with each foot 20 having one end portion sized and configured for mounting the restraint 10 upon the surface S.

Each foot 20, associated with one of the first and second spaced-apart pairs of legs 15A and 15B, includes another end portion (opposite the foot 20) which is dimensioned and configured to be extendable into (and retractable from) a hollow end portion of an associated one of the first and second spaced-apart pairs of legs 15A and 15B. An amount or degree of extension and/or retraction, measured from an upper portion of an endcap 19 (FIG. 4), on a lowermost portion of a foot 20, to a lower portion of a leg ranges between a first length value V1 (FIG. 4) and a second length value V2 (FIG. 5), when retracting end portions of feet 20 from the hollow end portions of the legs 15A, 15B (or disposing end portions of feet 20 into hollow end portions of the legs) for raising (or lowering) the saddle 30 relative to the surface S.

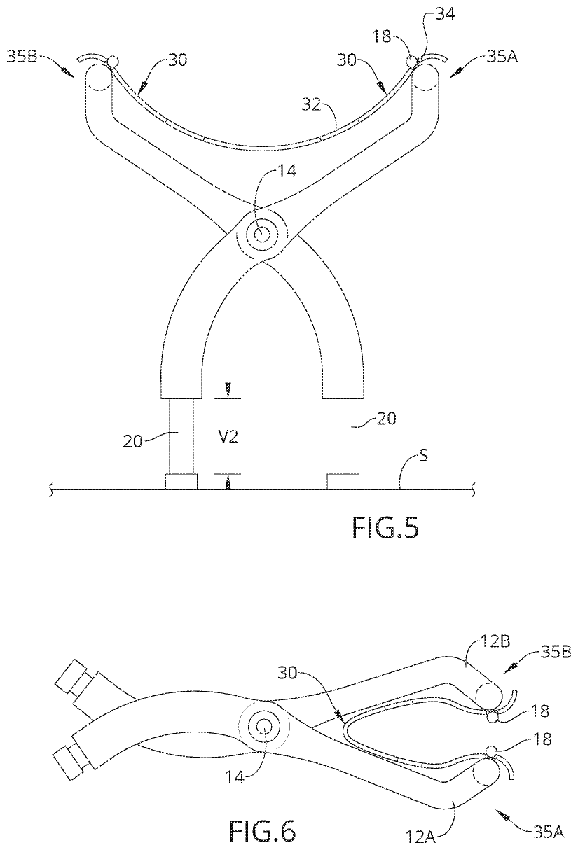

The restraint 10 may further include a locking mechanism 14 fixed to the connector 16 for enabling the U-shaped portions of the first and second suspension members 12A, 12B to be spaced apart and locked for supporting an animal on the saddle 30 as shown in FIG. 1. In addition, the locking mechanism 14 advantageously may be used for causing the U-shaped portions of the first and second suspension members 12A, 12B to be spaced closely adjacent (FIG. 6) causing an area otherwise oriented transverse to the first axis (and representing an outline of the restraint 10 when extended for its operative mode) to be reduced, to enable storing the restraint.

The locking mechanism 14 may comprise a spaced-apart pair of disc-like or annular projections or knobs 31A, 31B centered on the first longitudinal axis X-X (FIG. 2) at a location where one of the first and second suspension members 12A, 12B is pivotable (about the first axis X-X relative to the other suspension member).

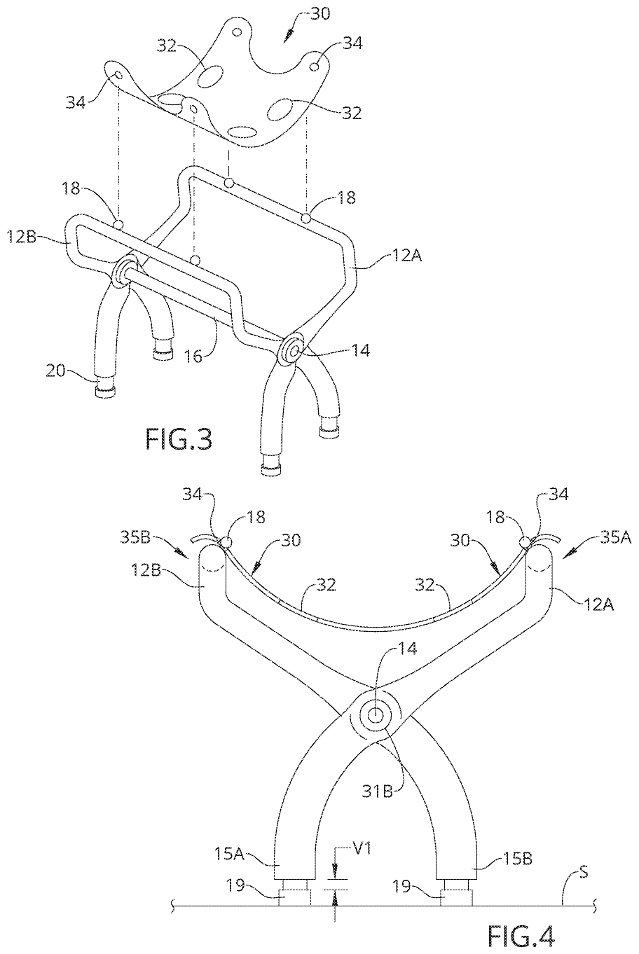

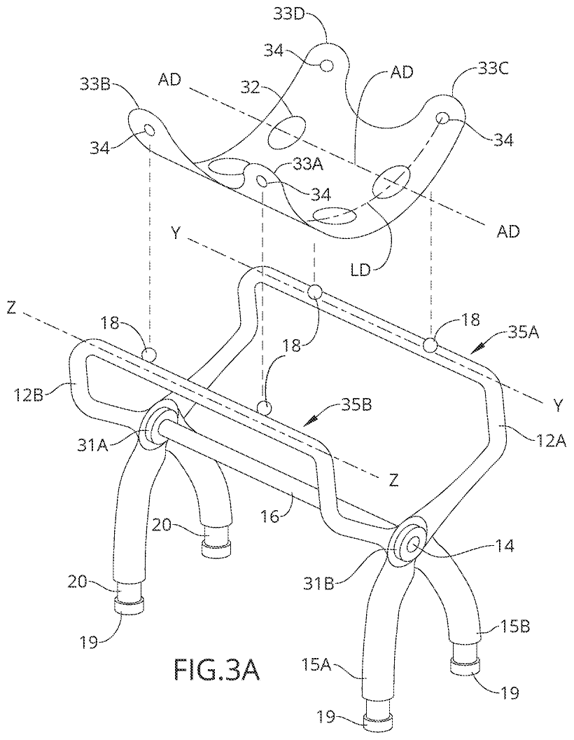

A spaced-apart pair of inner disc-like or annular projections or knobs 31A, mounted on the connector 16 adjacent inner surface portions of the first and second suspension members 12A and 12B, and a spaced-apart pair of outer disc-like or annular projections or knobs 31B, mounted on the connector 16 adjacent outer surface portions of the first and second members 12A and 12B could function as a locking mechanism. For example, the inner and outer knobs 31A and 31B (FIG. 3A) could be operatively coupled by a threaded fastener (not shown), so that when a person rotates both of the spaced-apart inner disc-like or annular projections or knobs 31A in a clockwise (or counterclockwise) direction relative to the associated spaced-apart pair of outer disc-like or annular projections or knobs 31B, the result could be to “lock” the first and second suspension members 12A, 12B into fixed arrangement. Reversing the rotation of one of the first and second suspension members 12A and 12B relative to the other could thus “release” members 12A, 12B.

In the restraint 10, the first suspension member 12A could further define a first elongated handrail 35A (FIGS. 4, 5) oriented along a second longitudinal axis Y-Y (FIG. 3). In addition, the second suspension member 12B could similarly define a second elongated handrail 35B (FIGS. 4, 5) oriented along a third longitudinal axis Z-Z (FIG. 3). The second and third axes Y-Y and Z-Z could be spaced parallel to each other. As a result, the first and second elongated handrails 35A, 35B could each be pivotable about the first axis X-X relative to the connector 16 for enabling spreading the handrails 35A and 35B apart and assuring that endcaps 19 are all firmly and flatly mounted on a surface or floor, for use. In addition, the first and second handrails 35A and 35B, each pivotable about the first axis X-X relative to connector 16, enable moving handrails 35A, 35B together for storing the restraint.

For the saddle 30, four of the plural spaced-apart end portions 33A, 33B, 33C, 33D may each define a relatively small aperture 34. (See FIGS. 2, 3A.) Also, the first and second handrails 35A and 35B may each define a spherical protrusion 18; and each protrusion 18 may be dimensioned and configured, and also oriented and spaced along its associated handrail 35A and 35B, for enabling each protrusion 18 to be disposable (preferably snugly) through a respective one of the apertures 34.

For the saddle 30, a first two of the plural apertures 32 could be spaced apart and arranged along an axial direction AD substantially parallel to the first axis X-X (FIG. 3A); and a second two of the plural apertures 32 could be spaced apart and arranged in a lateral direction LD substantially perpendicular to the first axis X-X. An aperture or apertures 32 may lie along both the axis AD and the axis LD.

For an animal to be gently cradled by the saddle 30, the spacing between the laterally directed apertures 32 could be (and preferably is) less than the spacing between apertures 32 in the axial direction. (See FIG. 3A). In addition, the four apertures 32 are shaped, sized, and spaced apart relative to each other for enabling the limbs of an animal to be easily insertable into and then freely extendable through without binding the limbs, to enable an animal caretaker to gently lower the animal onto the cradling upper surface of the saddle (FIG. 4) without stressing the animal.

What has been illustrated and described in this patent specification is a restraint designed to restrain an animal while enabling a preselected procedure such as a medical procedure or an animal-grooming procedure to calmly take place. While the present subject matter has been described in connection with a current embodiment, described and illustrated herein, the present subject matter is not limited to the current embodiment. On the contrary, many alternatives, changes, and/or modifications will become apparent to those of ordinary skill in the field of the present subject matter after this application has been read. Therefore, all such alternatives, changes, and modifications are to be viewed as part of the present subject matter insofar as they fall within the spirit and scope of the following claims.

What is claimed is:

1. A medical procedure restraint (10) for an animal, comprising:
a first suspension member (12A) for suspending an animal above a surface (S);
a second suspension member (12B) for suspending an animal above a surface (S);
an elongated connector (16) disposed along a first longitudinal axis (X-X) for pivotably connecting the first and second members (12A, 12B) and for enabling one of the first and second members (12A, 12B) to be rotatable about the first axis (X-X) relative to the other one of the first and second members (12A, 12B); and
a saddle (30) defining a plurality of spaced-apart apertures (32) and a plurality of spaced-apart end portions (33A, 33B, 33C, 33D), wherein each one of the first and second suspension members (12A, 12B) is dimensioned and configured to retain at least two of the plural saddle end portions (33A, 33B, 33C, 33D), wherein the first suspension member (12A) defines a first spaced-apart pair of legs (15A), wherein the second suspension member (12B) defines a second spaced-apart pair of legs (15B), and wherein the first pair of legs (15A) are spaced from the second pair of legs (15B), for supporting the restraint (10) upon a surface (S).

2. The medical procedure restraint (10) of claim 1, wherein the animal is a domesticated animal.

3. The medical procedure restraint (10) of claim 2, wherein the domesticated animal is a dog.

4. The medical procedure restraint (10) of claim 1, wherein the saddle (30) consists essentially of a deformable material, and wherein the first and second suspension members (12A, 12B) each define a U-shaped portion spaced from each pair of legs (15A, 15B).

5. The medical procedure restraint (10) of claim 1, wherein the spaced-apart legs (15A) of the first suspension member (12A) and the spaced-apart legs (15B) of the second suspension member each define open end portions located adjacent to the surface.

6. The medical procedure restraint (10) of claim 5, further including four feet (20), wherein each of the four feet (20) has one end portion configured and dimensioned for mounting the medical procedure restraint (10) upon the surface (S), wherein each of the four feet (20) has an opposite end portion dimensioned and configured to be extendable and retractable from the open end portion of each associated one of the first and second spaced-apart pairs of legs (15A, 15B) between a first length value (V1) and a second length value (V2) for lowering and raising the saddle (30) relative to the surface (S).

7. The medical procedure restraint (10) of claim 4, wherein the spaced-apart legs (15A) of the first suspension member (12A) and the spaced-apart legs (15B) of the second suspension member each define open end portions located adjacent to the surface.

8. The medical procedure restraint (10) of claim 7, further including four feet (20), wherein each of the four feet (20) has one end portion configured and dimensioned for mounting the medical procedure restraint (10) upon the surface (S), wherein each of the four feet (20) has an opposite end portion dimensioned and configured to be extendable and retractable from the open end portion of each associated one of the first and second spaced-apart pairs of legs (15A, 15B) between a first length value (V1) and a second length value (V2) for lowering and raising the saddle (30) relative to the surface (S).

9. The medical procedure restraint (10) of claim 6, further including a locking mechanism (14).

10. The medical procedure restraint (10) of claim 8, further including a locking mechanism (14) fixed to the connector (16) for enabling the U-shaped portions of the first and second suspension members (12A, 12B) to be spaced apart and locked for supporting an animal on the saddle (30) and for enabling the U-shaped portions of the first and second suspension members (12A, 12B) to be spaced closely adjacent, to cause an area oriented transverse to the first axis to be reduced, to enable storing the restraint.

11. The medical procedure restraint (10) of claim 1, wherein the first suspension member (12A) defines a first elongated handrail (35A) oriented along a second axis (Y-Y), wherein the second suspension member (12B) defines a second elongated handrail (35B) oriented along a third axis (Z-Z), wherein the second and third axes (Y-Y, Z-Z) are parallel and pivotable about the connector (16) for enabling movement of the handrails (35A, 35B) apart for use and together for purposes of storing the restraint.

12. The medical procedure restraint (10) of claim 8, wherein the first suspension member (12A) defines a first elongated handrail (35A) oriented along a second axis (Y-Y), wherein the second suspension member (12B) defines a second elongated handrail (35B) oriented along a third axis (Z-Z), wherein the second and third axes (Y-Y, Z-Z) are parallel and pivotable about the connector (16) for enabling movement of the handrails (35A, 35B) apart for use and together for purposes of storing the restraint.

13. The medical procedure restraint (10) of claim 12, wherein four of the plural spaced-apart end portions (33A, 33B, 33C, 33D) each define a small-sized aperture (34), wherein the first and second handrails (35A, 35B) each define a spherical protrusion (18), wherein each protrusion (18) is dimensioned and configured, and oriented and spaced along its associated handrail (35A, 35B), to enable each of the protrusions (18) to be disposable through a respective one of the small-sized apertures (34).

14. The medical procedure restraint (10) of claim 13, wherein a first two of the plural apertures (32) are spaced apart and arranged in an axial direction (AD) substantially parallel to the first axis (X-X), wherein a second two of the plural apertures (32) are spaced apart and arranged in a lateral direction (LD) substantially perpendicular to the first axis (X-X), and wherein the first and second two of the plural apertures (32) are each sized, configured and spaced apart relative to each other for enabling limbs of an animal to be disposable therethrough without unduly stressing the animal.

15. The medical procedure restraint of claim 14, wherein the animal is a domesticated animal.

16. The medical procedure restraint (10) of claim 15, wherein the domesticated animal is a dog.
